(19) United States
(12) Patent Application Publication
(10) Pub. No.: US 2003/0052095 A1
(43) Pub. Date: Mar. 20, 2003

(54) Plasma process and apparatus for cutting a cable

(75) Inventors: Nicholas A. Sanders, Norwich, VT (US); Brian Currier, Newport, NH (US)

Correspondence Address: TESTA, HURWITZ & THIBEAULT, LLP, HIGH STREET TOWER, 125 HIGH STREET, BOSTON, MA, 02110, US

(73) Assignee: Hypertherm, Inc., Hanover, NH

(21) Appl. No.: 10/247,011

(22) Filed: Sep. 19, 2002

Related U.S. Application Data
(60) Provisional application No. 60/323,242, filed on Sep. 19, 2001.

(51) Int. Cl. B23K 10/00

(52) U.S. Cl. 219/121.39; 219/121.51

(57) ABSTRACT

The invention features an apparatus and method for using a plasma arc torch to cut a workpiece in a cavity. The torch includes an adapter connectable to a torch body and remote torch head, establishing a spaced relationship between them, for positioning the torch head adjacent the workpiece in the cavity. The system includes a grounding member useful for operating the torch in a transferred mode, a clamping plate for retaining a severed portion of the workpiece, and a torch tip design that allows the torch head to be positioned within the cavity.

### RELATED APPLICATIONS

This application claims benefit of U.S. Provisional Application No. 60/323,242, filed Sep. 19, 2001. The entire disclosure of this application is incorporated herein by reference.

### TECHNICAL FIELD

The invention relates generally to processes and apparatuses for processing a workpiece. More specifically, the invention relates to processes and apparatuses for cutting a cable using a plasma arc torch.

### BACKGROUND

Post-tensioning is a method of reinforcing or strengthening concrete with cables. The cables (often referred to as tendons) are typically made up of high-strength steel strands. Post-tensioning applications include, for example, office and apartment buildings, parking structures, slabs-on-ground, bridges, sports stadiums, rock, and soil anchors, and water-tanks. An unbonded tendon is one in which the tendon is not actually bonded to the surrounding concrete. Tension forces in the unbonded tendon are transferred to the concrete by anchorages located near the perimeter of the concrete.

The most common unbonded methods use monostrand (i.e., single strand) tendons. In one embodiment, a monostrand tendon is a steel cable that consists of a seven-wire strand coated with corrosion-inhibiting grease and encased in an extruded plastic protective sheathing. These seven-wire strand steel cables have typical diameters of between one-half and five-eighths inches. The anchorage can be an iron casting in which the tendon is gripped by a conical, two-piece restraining wedge.

After the concrete has cured and obtained the necessary strength, a jack is used to stretch and apply tension to the tendon. Wedges are inserted inside the anchor casting cavity and the tendon is stressed. When the jack releases the tendon, the tendon retracts slightly and pulls the wedges into the anchor, creating a tight lock on the tendon. The wedges thus maintain the applied force in the tendon and help transfer the force to the surrounding concrete. For corrosion protection, the anchorages and exposed tendon ends are covered with a housing and a cap. To ensure that the housing and cap are installed properly, the tendon ends need to be cut off within three-quarters of an inch from the wedges.

Typically, the anchorages are located on the edge of a concrete slab or column (beam), but recessed in about one to three inches so that the anchorage can be capped and covered with cement for corrosion protection. Several patents (e.g., U.S. Pat. Nos. 4,896,470 and 5,072,558) have addressed the problems of corrosion in this type of construction and discuss various methods of assembly and design.

All of the methods used to protect the tendons from corrosion require that the cable anchorage and holding wedges be recessed into the concrete. This requires that the end of the tendon be cut just outside of the stressing wedges, and within the cavity formed in the concrete structure. Typically, post-tensioning tendon systems are engineered to be cut off within five-eighths to three-quarters of an inch from the restraining wedges. For deeper cavities, the cable cut must be made further into the cavity, farther away from the exterior surface of the concrete structure.

A conventional acetylene (oxy-fuel) torch is most commonly used in the prior art for cutting the tendon ends. However, use of the oxy-fuel torch requires a substantial preheat to the tendon in order to cut it, creating a danger of fire or explosion in the surrounding environment. Also, cutting near the tensioning wedges can cause the tendon and/or wedges to become overheated, altering their material properties, leading to subsequent tendon failure. In addition, the oxy-fuel torches are not designed to cut the tendon inside the cavity, leading to a total lack of consistency and tolerance control of the position of the cut, and can further lead to poor corrosion protection, sealing, and to damage to the anchorage and/or stressing tendon.

Torch positioning devices have also been used to cut the ends of restrained tendons. For example, U.S. Pat. Nos. 5,436,425 ('425 patent) and 6,040,546 ('546 patent) describe the use of torch positioning devices for use in cutting tendon ends. The '425 patent describes the use of a conventional plasma arc torch for cutting tendon ends. The '546 patent describes the use of an oxy-fuel torch for cutting tendon ends. One of the stated objectives described in the '425 and '546 patents is to cut the free end of the tendon within the pocket formed for the anchorage. However, this is only accomplished by pre-designing the poured concrete with a specially-designed cavity, that has larger dimensions, and which is shaped to receive the described positioning devices of the '425 and '546 patents. One example is a keyhole-shaped cavity. Thus, these positioning devices can not be used within a standard cavity, but are only usable either on specially designed concrete structures or at a location outside of the cavity. The confined area of a standard cavity has dimensions which are too small to accommodate the devices of the '425 or the '546 patents. In general, standard cavities are generally circular and have a diameter of about 4 to 6 inches.

An additional problem with the devices described in the '425 patent is that there is no method described for establishing a ground connection to the tendon (or workpiece). In general, the post-tensioned tendons are not, by design, grounded to earth. As such, there is no intrinsic current return path for the plasma when a plasma arc torch is used. The described plasma torch would only work in a non-transferred plasma mode of operation. The non-transferred plasma mode of operation gives rise to a tremendous heat input, with very poor cutting capability and performance.

One alternative industry method for trimming the post-tensioned tendon ends includes use of an electric saw. However, the electric saw is not designed to enter the cavity and requires a portion of the concrete to be removed. Another alternative industry method for trimming the post-tensioned tendon includes use of a hydraulic cutter, which is designed to go into the cavity and cut the tendon ends at an operator-specified distance from the restraining wedges. However, because of poor equipment reliability, space constraints, and user difficulties, neither the electric saw nor the hydraulic cutter has achieved widespread use.

What is needed is a method and apparatus for removing the end of a cable within a confined area, that provides a controllable and uniform cut to the cable, produces less heating of the non-removed portion of the cable, and effectively establishes a ground with the end of the cable being removed.

### SUMMARY OF THE INVENTION

In one aspect, the invention features an adapter for enabling a plasma arc torch to be used to cut a portion of a workpiece disposed within a cavity. The plasma arc torch has a torch body and a torch head. The adapter comprises a neckpiece connectable to the torch body and the torch head, including flow paths from the torch body and to the torch head for electrical current and at least one gas. The torch head is positionable within the cavity, adjacent the workpiece, and the torch head and the torch body are in a spaced relationship. One embodiment includes a rotatable attachment adjacent a first end of the neckpiece, connectable to the torch body. The rotatable attachment provides for the flow electrical current and at least one gas between the torch body and the neckpiece. The rotatable attachment can allow a user-selectable orientation of the torch body about an axis of the rotatable attachment.

Embodiments of the adapter comprise flow paths for at least one of a primary current lead and a pilot arc lead to transfer a primary current or a pilot arc to the torch head. The adapter can include a plasma gas flow path to transfer a plasma gas from the torch body to the torch head. The adapter can also comprise a grounding portion fixedly mounted to a first end of the neckpiece to maintain electrical continuity between the workpiece and a power supply to the plasma arc torch. The adapter can include a clamping plate adjacent a first end of the neckpiece having an interior surface opposite a surface of the adapter. A tensioning member can create a biasing compressive force between the interior surface of the clamping plate and the surface of the adapter, such that they can retain a severed portion of the workpiece.

Another aspect of the invention features an adapter for cutting a workpiece having at least a portion disposed within a cavity, for use with a plasma arc torch having a torch body and a torch head, the adapter comprising a neckpiece connectable to the torch head and the torch body such that the torch head is disposed in a spaced relationship relative to the torch body. The neckpiece can comprise flow paths for providing electrical current and at least one gas from the torch body to the torch head. The adapter can also include a grounding portion fixedly mounted to a first end of the neckpiece, to maintain electrical continuity between the workpiece and a power supply to the plasma arc torch. Embodiments include a grounding portion further comprising a strain relief member. The strain relief member can include a pass-through hole for supporting a grounding cable.

In other embodiments the adapter includes a clamping plate disposed adjacent the first end of the neckpiece and having an interior surface disposed opposite a surface of the adapter. A tensioning member can create a biasing compressive force between the interior surface of the clamping plate and the surface of the adapter, such that they can retain a severed portion of the workpiece.

Another aspect of the invention features an adapter for use with a plasma arc torch for cutting a workpiece having at least a portion disposed within a cavity, the plasma arc torch having a torch body and a torch head. The adapter includes a neckpiece having a first and second end, and connectable to the torch head and the torch body such that the torch head is disposed in a spaced relationship to the torch body. A clamping plate can extend from the neckpiece, including an interior surface disposed opposite a surface of the adapter. A tensioning member can be disposed between the clamping plate and the adapter, creating a biasing compressive force between the interior surface of the clamping plate and the surface of the adapter, such that they can retain a portion of the workpiece.

An embodiment includes a retainer disposed along the interior surface, the retainer retaining a severed portion of the workpiece between the clamping plate and the adapter. The retainer can comprise an interior retention ridge.

The adapter can further include a grounding portion fixedly mounted to the first end of the neckpiece, to maintain electrical continuity between the workpiece and a power supply to the plasma arc torch.

Another aspect features a plasma arc torch tip for processing a workpiece having at least a portion disposed within a cavity including a torch head for generating a plasma arc for processing the workpiece, the torch head comprising an electrode and a nozzle positionable in a spaced relationship to define a plasma chamber in which a plasma arc is formed. The plasma torch tip also includes an adapter comprising a neckpiece connectable to the torch head and a torch body, such that the torch head is disposed in a spaced relationship relative to the torch body and is positionable within the cavity adjacent the workpiece. The neckpiece comprises flow paths for providing electrical current and at least one gas from the torch body to the torch head, to generate and sustain the plasma arc.

An embodiment of the torch tip includes a substantially planar shield, a front face of the shield disposed adjacent a front face of the adapter such that a plasma gas flow path through the plasma chamber is substantially transverse to a longitudinal axis of the adapter. In another embodiment, the nozzle comprises an exit orifice that is substantially coplanar with a front face of the adapter, and wherein a plasma gas flow path through the plasma chamber is substantially transverse to a longitudinal axis of the adapter. The torch head can include at least one of a swirl ring and a retaining cap. The substantially planar shield can be vented or non-vented. One or more bleed vents can be disposed in a groove or on a side wall of the shield.

An embodiment of the torch tip includes a grounding portion fixedly mounted to a first end of the neckpiece, to maintain electrical continuity with the workpiece. The torch tip can also include a clamping plate disposed adjacent a first end of the neckpiece, having an interior surface disposed opposite a surface of the adapter. A tensioning member can create a biasing compressive force between the interior surface of the clamping plate and the surface of the adapter, such that a portion of the workpiece can be retained between the interior surface and the surface of the adapter.

Another aspect of the invention features a plasma arc torch for processing a workpiece having at least a portion disposed within a cavity, the plasma arc torch comprising a plasma arc torch body and a torch head. The torch head is for generating a plasma arc for processing the workpiece and includes an electrode and a nozzle positionable in a spaced relationship to define a plasma chamber in which the plasma arc is formed. The plasma arc torch also includes an adapter including a neckpiece for positioning the torch body in a spaced relationship relative to the torch head, the neckpiece comprising flow paths for providing electrical current and at least one gas from the torch body to the remote torch head. The flow paths are substantially transverse to the plasma arc, and the remote torch head and a portion of the adapter fit within the cavity when processing the portion of the workpiece disposed within the cavity. A power supply for providing electrical current to the adapter can be electrically coupled to the adapter.

Another embodiment includes a grounding portion to maintain electrical continuity between the workpiece and the power supply, fixedly mounted to a first end of the neckpiece. The plasma arc torch can also include a clamping plate having an interior surface disposed opposite a surface of the adapter disposed adjacent a first end of the neckpiece. A tensioning member can create a biasing compressive force between the interior surface of the clamping plate and the surface of the adapter, such that can retain a severed portion of the workpiece.

Another aspect of the invention features a method for cutting a portion of a workpiece disposed within a generally circular cavity, using a plasma arc torch comprising a torch body and a torch head. The workpiece has a workpiece longitudinal axis. The method includes inserting at least a portion of the torch tip within the generally circular cavity, the torch tip comprising a plasma arc torch head for generating a plasma arc that impinges upon the portion of the workpiece disposed within the generally circular cavity, and an adapter for positioning the torch head in a spaced relationship relative to the torch body, the adapter having an adapter longitudinal axis. The method also includes manipulating the torch tip within the generally circular cavity to cut the workpiece with the plasma arc, such that the workpiece longitudinal axis and the adapter longitudinal axis remain substantially parallel.

In one embodiment, manipulating includes at least one of rocking the torch tip about the adapter longitudinal axis and rotating the torch tip about the workpiece longitudinal axis. Another embodiment includes providing a rotatable attachment connectable to the torch body, and providing a flow of electrical current and at least one gas between the torch body and the adapter. The method can include manipulating the torch body about an axis of the rotatable attachment to achieve a selected orientation with respect to the adapter. Another embodiment includes removing the portion of the workpiece. The method can include grounding the workpiece with a power supply to the plasma arc torch utilizing a grounding portion fixedly attached to the adapter. Retaining the portion of the workpiece using a clamping member fixedly attached to the plasma torch can also be included.

Yet another aspect of the invention features a method for cutting a portion of a workpiece disposed within a cavity using a plasma arc torch that includes a power supply, a torch body, and a torch tip. The method includes inserting at least a portion of the torch tip within the cavity, the torch tip including a torch head for generating a plasma arc that impinges upon the portion of the workpiece disposed within the cavity and an adapter for positioning the torch head in a spaced relationship relative to the torch body. The method can include electrically connecting the workpiece and the power supply using a grounding member fixedly attached to the adapter, and manipulating the torch tip within the cavity to cut the workpiece with the plasma arc. In some embodiments the method includes providing a rotatable attachment connectable to the torch body, which provides for a flow of electrical current and at least one gas between the torch body and the adapter, and manipulating the torch body about an axis of the rotatable attachment to achieve a selected orientation with respect to the adapter.

Another aspect of the invention features a method for cutting a cable disposed within a cavity, comprising providing a plasma arc torch having a torch body and a torch head, an adapter connecting the plasma arc head in a spaced relationship with the torch body, the adapter comprising flow paths for providing electrical current and at least one gas from the torch body to the torch head. The method also includes inserting the torch head and at least a portion of the adapter into the cavity such that the torch head is adjacent to the cable, generating the plasma arc, and manipulating the torch head within the cavity to cut the cable with the plasma arc.

An aspect of the invention features a low-profile shield for use on a plasma arc torch head capable of cutting a portion of a workpiece disposed within a cavity, the plasma arc torch head disposed within the cavity and having a nozzle and an electrode disposed in a spaced relationship to define a plasma chamber in which a plasma arc is formed, an adapter connecting the plasma arc torch head and a plasma arc torch body in a spaced relationship. The shield comprises a substantially planar body portion having a front face disposed adjacent a face of the adapter for substantially preventing molten material generated during cutting of the workpiece from reaching the nozzle and electrode, the substantially planar body portion defining a central exit orifice through which the plasma arc exits the shield. The shield includes a fastening mechanism disposed relative to the substantially planar body portion for securing the shield to the torch head, wherein the substantially planar body portion has at least one side surface dimensioned to minimize the profile of the torch head.

The low-profile shield can include one or more bleed vents, and the one or more bleed vents can be located in a recessed groove on a front face of the low-profile shield. The bleed vents can also be disposed on a side wall of the shield. In some embodiments, the low-profile shield is non-vented. The substantially planar portion of the low-profile shield can include a generally circular portion surrounded by a frame portion.

### BRIEF DESCRIPTION OF THE DRAWINGS

The foregoing and other objects, features and advantages of the present invention, as well as the technology itself, will be more fully understood from the following description and embodiments, when read together with the accompanying drawings, in which:

FIG. 1A shows a cross-section view of one embodiment of a plasma arc torch;

FIG. 1B shows a schematic view of an apparatus for cutting a workpiece according to one embodiment of the invention;

FIG. 1C shows a schematic view of a clamping plate according to another embodiment of the invention;

FIG. 2 shows another schematic view of an apparatus for cutting a workpiece according to one embodiment of the invention;

FIG. 3A shows a top view of an adapter for a plasma arc torch;

FIG. 3B shows a front view of an adapter for a plasma arc torch;

FIG. 3C shows a side view of an adapter for a plasma arc torch;

FIG. 4A shows a perspective view of an adapter for a plasma arc torch with a partial cut away of a grounding portion;

FIG. 4B shows another embodiment of grounding portion, comprising a strain relief member;

FIG. 4C shows a schematic view of an embodiment of the invention comprising a strain relief member;

FIG. 5 shows an exploded view of an adapter and a remote torch head for a plasma arc torch when a neckpiece cover is removed; and

FIG. 6 shows a perspective view of an adapter for a plasma arc torch in conjunction with an exploded view of a remote torch head that can be attached to the adapter.

### DETAILED DESCRIPTION

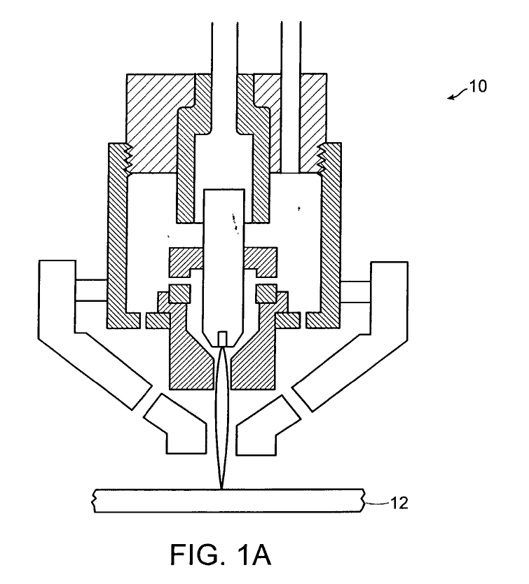

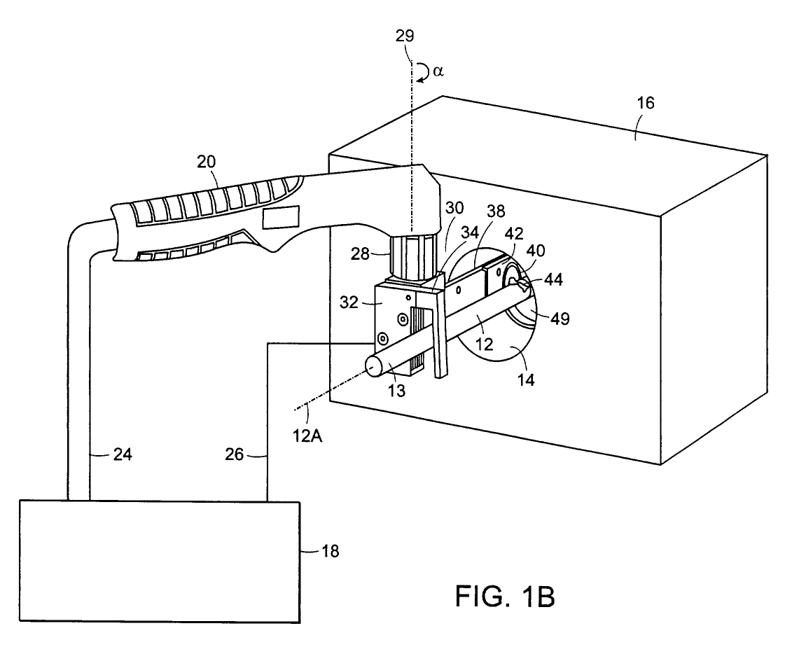

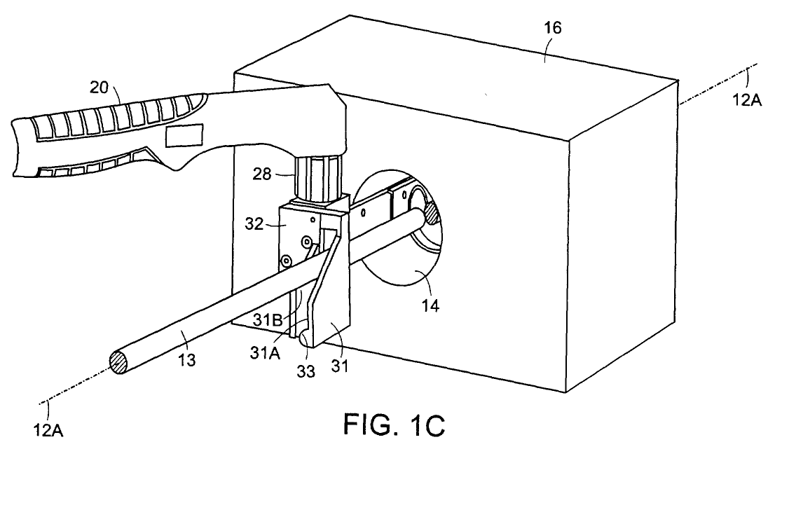

Plasma arc torches are widely used in the cutting of metallic materials, including metallic cables. FIG. 1A illustrates a cross-sectional view of one embodiment of a plasma arc torch. FIG. 1A is for illustrative purposes only, and is not intended to represent the torch of a specific manufacturer. A plasma arc torch can include a torch body, an electrode mounted within the body, a nozzle with a central exit orifice, electrical connections, passages for cooling and arc control fluids, a swirl ring to control the fluid flow patterns, and a power supply. Gases used in the torch can be non-reactive (e.g., argon or nitrogen), or reactive (e.g., oxygen or air). The torch produces a plasma arc, which is a constricted ionized jet of a plasma gas with high temperature and high momentum.

There are two widely used techniques for generating a plasma arc. One technique uses a high frequency, high voltage (HFHV) signal coupled to a DC power supply and the torch. The other technique for generating a plasma arc is known as contact starting. One form of contact starting can be found in U.S. Pat. Nos. 4,791,268 and 4,902,871 assigned to Hypertherm, Inc. The disclosures of both patents are incorporated herein by reference.

Using either starting technique, a pilot arc is first generated between the electrode (cathode) and the nozzle (anode). The pilot arc ionizes gas passing through the nozzle exit orifice. After the ionized gas reduces the electrical resistance between the electrode and the workpiece, the arc transfers from the nozzle to the workpiece. The torch is operated in this transferred plasma arc mode, which is characterized by the conductive flow of ionized gas from the electrode to the workpiece, for the cutting of the workpiece.

Plasma arc cutting torches can produce a transferred plasma arc with a current density that is in the range of 20,000 to 40,000 amperes/in². High definition torches are characterized by narrower jets with higher current densities, typically about 60,000 amperes/in². High definition torches produce a narrow cut kerf and a square cut angle. Such torches also have a thinner heat affected zone and are more effective in producing a dross free cut and blowing away molten metal. Either type of torch can be adapted for use in connection with the present invention.

FIG. 1B illustrates a plasma arc torch system 10 according to the invention. The plasma arc torch can be used to cut a workpiece 12 in a cavity 14. In one embodiment, the cavity 14 can be formed in a slab of concrete 16, and the workpiece 12 can be a tendon used to support the concrete 16. The system 10 includes a power supply 18, a plasma arc torch body 20, and an adapter 22 to facilitate the cutting of the workpiece 12 in the cavity 14. For use at a construction site, a generator and/or a compressor may be employed to provide current and gas for the plasma arc torch. In one embodiment, the power supply 18 and the plasma arc torch body 20 can be portions of a Powermax® 1250 plasma arc torch system manufactured by Hypertherm, Inc. of Hanover, N.H. Other systems can be used without departing from the spirit and scope of the invention described herein.

The power supply 18 is connected to the plasma arc torch body 20 by a hose 24. The hose 24 provides the torch body 20 with a plasma gas from a gas source (not shown) and electrical power from the power supply 18 to ignite and sustain a plasmajet. The adapter 22 is connectable to the torch body 20 and the remote torch head 42. In addition, the adapter can comprise flow paths for providing electrical current and at least one gas from the torch body to the torch head. As shown, these flow paths can be substantially transverse to the plasma arc 44. Air can be used as the plasma gas, but other gases can also be used to improve cut quality on metals such as stainless steel or aluminum. A grounding cable 26 provides a return path for current generated by the power supply 18, which is connected to the workpiece 12 by a grounding portion 32.

The adapter 22 can be connected to the torch body 20 by a rotatable attachment 28, located proximate a first end 30 of the adapter. In one embodiment, the rotatable attachment 28 can be a threaded nut. The adapter 22 can be attached to the torch body 20 at any given angle a, measured about an axis of the rotatable attachment 29. This allows a user to orient the adapter 22 relative to the torch body at a selected angle, providing optimal access to a workpiece located in a hard-to-reach area such as a cavity 14. In embodiments with and without the rotatable attachment 28, the remote torch head 42 is positionable within the cavity 14 using the adapter 22. This allows the torch head to be positioned adjacent to the workpiece 12 such that the plasma arc 44 impinges on the workpiece within the cavity. The adapter can be configured to allow the plasma arc 44 to cut the workplace deep (e.g., up to several inches) within the cavity 14, for example, as shown in FIG. 1B.

The adapter 22 further includes a neckpiece 38 that extends between the first end 30 and a second end 40 of the adapter. The neckpiece 38 can be used to provide electrical current and at least one gas from the first end 30 to the second end 40 of the adapter 22. The neckpiece 38 of the adapter can be connectable to the remote torch head 42 and the torch body 20. The neckpiece can also be connected to the rotatable attachment 28.

In one embodiment, the neckpiece 38 can be made of high temperature resistant plastic, such as Vespel™. The length of the neckpiece 38 can be designed to meet the needs of a particular application, ranging from a length of a couple inches to several feet long. Longer neckpieces are used for deeper cavities. As described above, the workpiece is preferably cut within about ⅝ to ¾ of an inch of the restraining wedges, located near anchorage 49. The neckpiece 38 facilitates the supply of current and gas to a remote torch head 42 secured at the second end 40 of the adapter. The remote torch head 42 can be a remote torch head of a plasma arc torch.

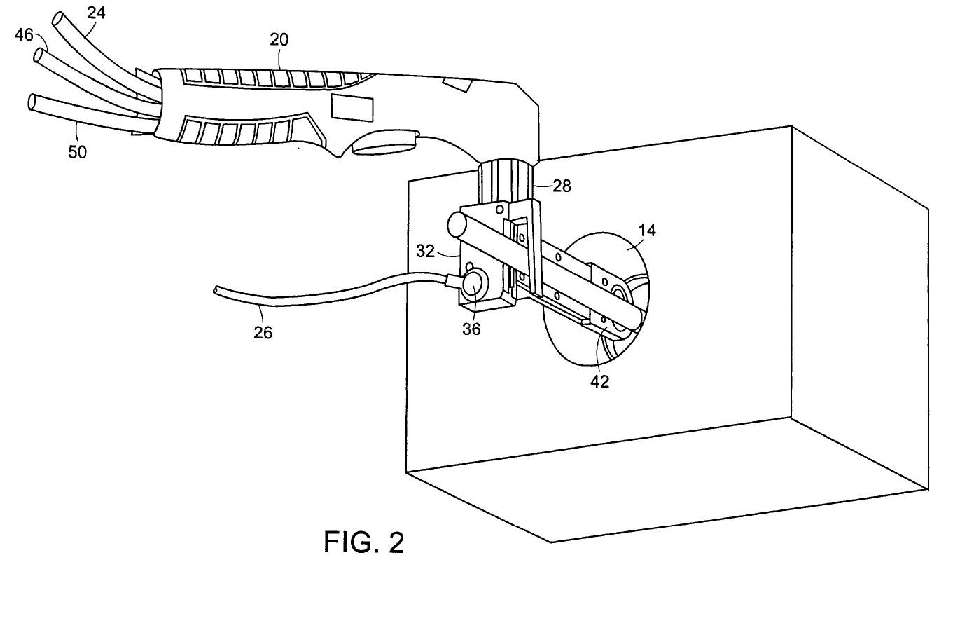

The adapter 22 can include a grounding portion 32 located proximate the first end 30 of the adapter. The grounding portion 32 can be fixedly attached to the adapter 22 (e.g., as shown in FIG 1B), and can provide electrical continuity between the workpiece and the power supply 18. The grounding portion 32 can be used to ground the end of the workpiece being cut 13 with the power supply 18 when the torch is operated in a transferred mode. In other embodiments, the grounding member 32 can be fixedly mounted to the neckpiece. The grounding portion 32 can include a grounding lug 36 (FIG. 2) connected to the grounding cable 26. The grounding cable 26 electrically connects the workpiece with the power supply 18 in the transferred arc mode of operation. The grounding portion 32 can include a workpiece holder 34 for securely holding the workpiece 12.

Some embodiments of the invention feature a torch tip, for example, including an adapter 22 and remote torch head 42 as shown. The torch tip is connectable to a torch body 12, and can include, for example, the grounding portion 32, the rotatable attachment 28, and a clamping plate 31. At least the remote head 42 of the torch tip can be positioned within a cavity for cutting a workpiece.

FIG. 1C shows an embodiment of the plasma arc torch that further includes a clamping plate 31 (also known as a cable catcher) to catch the cable end 13 of the workpiece 12 when it is cut. The size and shape of the clamping plate can be adapted to retain the cut end 13 of the workpiece when it is severed. The clamping plate includes an interior surface 31A disposed opposite a surface of the adapter 31B for retaining the severed portion of the workpiece 13. The clamping plate 31 prevents the cut piece of the end 13 from falling, and possibly causing harm or inconvenience below. In one embodiment, the clamping plate 31 is located near the workpiece end 13 that is to be captured, and includes a retainer such as an interior retention ridge 33 to help prevent the end 13 of the workpiece from dropping away. The cut end 13 can be removed from the clamping plate 31 each time a cable is cut.

The components internal to the hose 24 that runs from the power supply to the plasma arc torch body 20 are shown in FIG. 2. A pilot arc lead 46 and a primary current lead 48 provide current to the plasma arc torch body 20. A gas hose 50 supplies gas to the plasma arc torch body 20, and the grounding cable 26 is electrically connected to the grounding lug 36.

In one embodiment, the grounding lug 36 is located at an end of the adapter away from the remote torch head 42 and adjacent the end of the workpiece 12. The grounding lug 36 is electrically isolated from both the pilot arc lead 46 and the primary power lead 48, being designed as a return path to the power supply 18 for current coming from the workpiece 12 during the cutting process. By making electrical contact to the workpiece 12 via the grounding lug 36, the electric current return path to the power supply 18 is established in a safe and reliable way. Because of the need to isolate the workpiece 12 (tendons) and anchorage 49 (FIG. 1B) for corrosion protection purposes, the workpiece 12 is by design typically not intentionally grounded to earth. Such workpieces can be electrically “floating.” The present invention overcomes this problem by providing the electrical return path through the grounding lug 36.

In addition, because the grounding cable 26 is attached near the end 13 of the workpiece 12, the current from a plasma arc 44 flows through the workpiece 12 and through the grounding cable 26 in a direction away from the anchorage 49. This technique minimizes heating of the anchorage 49 by directing heat away from the anchorage 49.

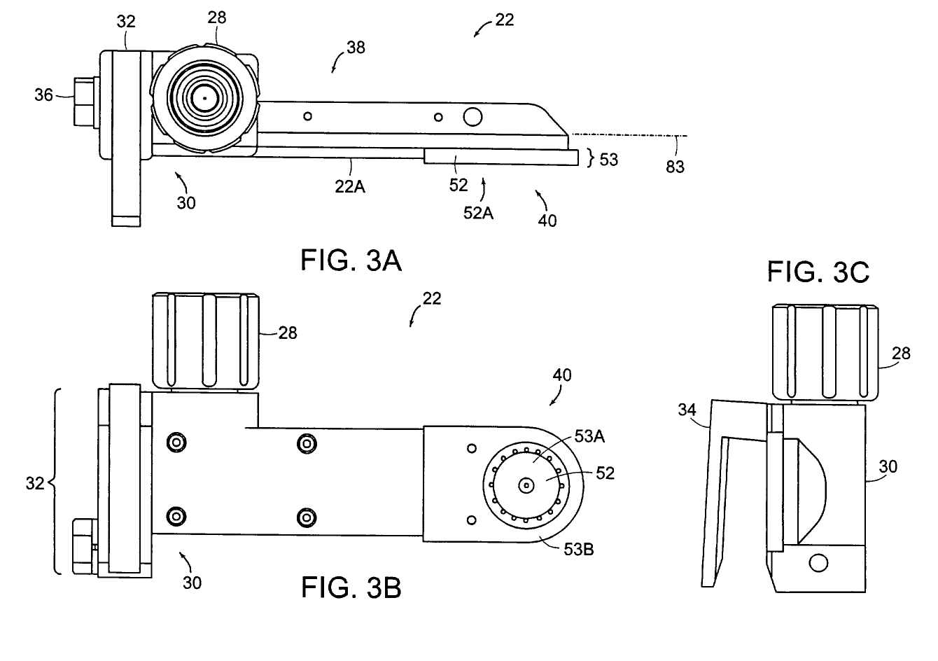

FIG. 3A illustrates a top view of the adapter 22. As shown, the grounding lug 36 and the rotatable attachment 28 are located proximate the first end 30 of the adapter. The neckpiece 38 extends from the first end 30 and toward the second end 40 of the adapter. A shield 52, which is part of the remote torch head 42, is generally proximal to the second end 40 of the adapter. In one embodiment, a front face 52A of the shield 52 is generally co-planer with a front face of the adapter 22A, such as a surface of the neckpiece 38. The shield is substantially planar in some embodiments, and is generally disposed adjacent the front face 22A of the adapter. The front face 22A of the adapter generally is disposed in an orientation that parallels the longitudinal axis 83 of the adapter.

The shield substantially prevents molten material generated during cutting of the workpiece from reaching the nozzle 74 and the electrode 72, discussed below. At least one side surface of the shield (e.g., 53) can be dimensioned to minimize the profile of the torch head. In some embodiments the shield comprises a generally circular portion 53A surrounded by a frame portion 53B (e.g., FIG. 3B).

FIG. 3B illustrates a front view of the adapter 22. As shown, the grounding portion 32 and the rotatable attachment 28 are proximate the first end 30 of the adapter. The neckpiece 38 extends between the first end 30 and the second end 40 of the adapter. The remote torch head 42 is proximal to the adapter second end 40.

FIG. 3C illustrates a side view of an embodiment of the adapter 22 and shows the workpiece holder 34 and rotatable attachment 28 in relation to the adapter first end 30.

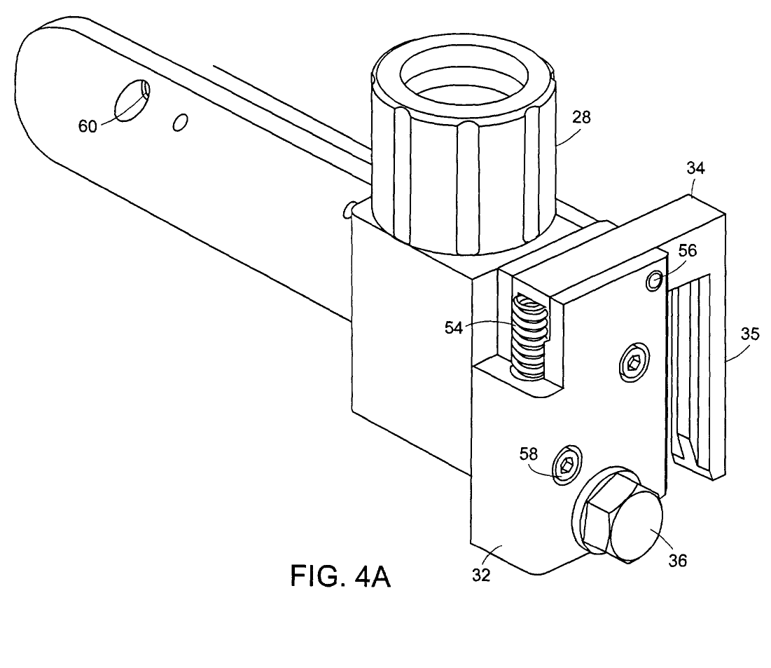

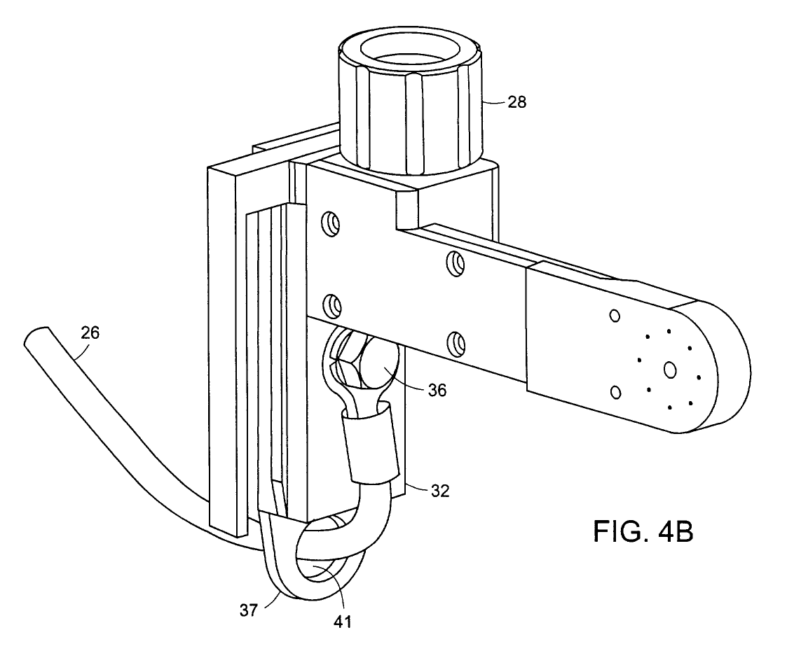

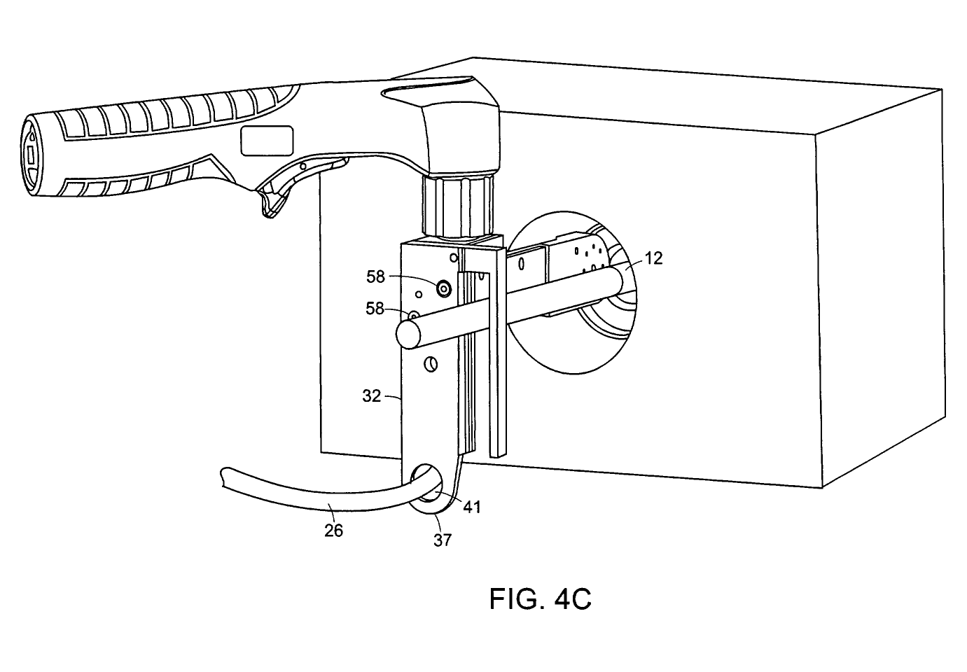

FIG. 4A illustrates a perspective view of the adapter 22 and shows a partial cut away view of the grounding portion 32. The cut away view of the grounding portion 32 illustrates the workpiece holder 34. In one embodiment, the workpiece holder 34 can include an arm 35 connected to a tensioning member 54 that creates a biasing compressive force, such as a loading spring. The tensioning member 54 maintains a positive contact between the workpiece holder 34 and the workpiece 12. The tensioning member 54 can also be used in the embodiment of the invention comprising a clamping plate 31 (FIG. 1C). In this embodiment, the tensioning member 54 can be sized to exert sufficient force on the cut cable end 13 between the interior surface of the clamping plate 31A and the surface of the adapter 31B to keep the cable end 13 from dropping away after the cut has been made. The tensioning member 54 can have a force constant of 60 lb/in. In another embodiment, sufficient force to establish an effective grounding connection can be exerted on the cable end 13 from contact with the arm 35 and the grounding portion 32 without the use of tensioning member 54.

The workpiece holder 34 is connected to the grounding portion 32 by a pivot pin. The pivot pin 56 allows the workpiece holder 34 to rotate so the workpiece 12 can be engaged and disengaged by the workpiece holder 34. The grounding portion 32 can be connected to the adapter 22 with grounding-portion mounting screws 58. In addition, shield screws 60 can be used to connect the shield 52 to the adapter 22.

FIGS. 4B and 4C illustrate another embodiment of the grounding portion 32 further including a strain relief member 37. In this embodiment, the grounding cable 26 is attached to the grounding lug 36 and passes through the strain relief member 37. The strain relief member 37 provides physical support to the grounding cable 26, in combination with the grounding lug 36. Proper support of the grounding cable 26 preserves the integrity of the connection of the grounding cable 26 at the grounding lug 36, and helps to minimize wear and fraying of the cable. The strain relief member 37 can also be configured to direct the grounding cable 26 away from the workpiece 12, to prevent the grounding cable 26 from interfering with the cutting operation. The grounding cable 26 traverses a pass-through hole 41 located in the strain relief member 37. The strain relief member 37 can be located at a distal portion of the grounding member 32, and it can be secured with grounding-portion mounting screws 58.

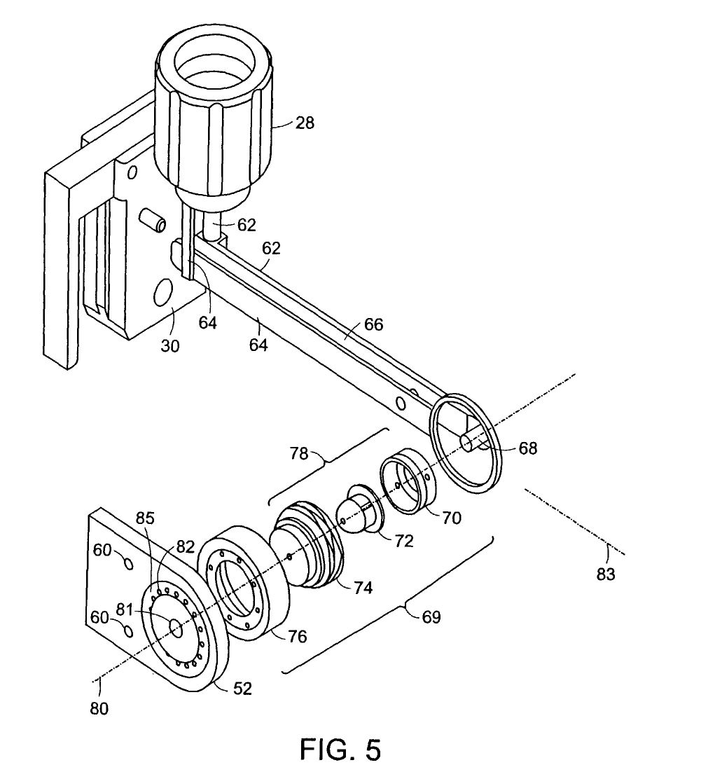

FIG. 5 illustrates an exploded view of the adapter and the remote torch head 42 when the neckpiece cover 84 is removed. As shown, an adapter primary current lead 62 and an adapter pilot arc lead 64 are used to transfer current from the plasma arc torch body (not shown) through the adapter rotatable attachment 28 to the remote torch head 42. In one embodiment, the adapter primary current lead 62 and the adapter pilot arc lead 64 can be manufactured by laser cutting a piece of copper sheet. In another embodiment, the adapter primary current lead 62 and the adapter pilot arc lead 64 can be wires. A plasma gas channel 66 is formed between the adapter primary current lead 62 and the adapter pilot arc lead 64 to transfer gas from the plasma arc torch body (not shown) through the adapter rotatable attachment 28 to the remote torch head 42. An electrode mounting screw 68 is located proximate the adapter second end 40.

The remote torch head 42 assembly includes a torch tip 69 and a shield 52. The torch tip 69 can include a swirl ring 70, an electrode 72, a nozzle 74, and a retainer cap 76. The electrode 72 is mounted to the electrode mounting screw 68. In one embodiment, the swirl ring 70 has a set of holes (not shown) to impart a tangential velocity component to the gas to cause it to swirl. The electrode 72, the nozzle 74, and the swirl ring 70 define a plasma chamber 78. The shield 52 can be secured to the adapter 22 by shield screws 60, such that the shield 52 secures the torch tip 69 to the adapter 22. In some embodiments, the shield includes a fastening mechanism disposed relative to the substantially planar body portion of the front face of the shield 52A for securing the shield to the torch head 42. The fastening mechanism can comprise at least one of the retainer cap 76 and the electrode mounting screw 68 (see FIG. 5).

When assembled, the shield 52, the nozzle 74 and the retaining cap 76 are generally co-linearly disposed about an axis 80 of the torch head that is substantially transverse to a longitudinal axis of the adapter 83. The plasma arc 44 exits the torch head in a direction parallel with axis 80 of the torch head when the torch is in operation. In one embodiment, the shield 52 has a low-profile construction with a substantially planar front face 52A. As such, when the shield 52 is secured to the adapter the front face 52A of the shield is generally co-planar relative to a surface of the neckpiece of the adapter.

In some embodiments, the shield is vented. The shield 52 can have bleed vents 82. The bleed vents can be shaped as holes, slots, other shapes, and the like. The bleed vents can be located in the front face or in a side wall. In another embodiment, the bleed vents 82 are recessed in a groove 85 in the front face 52A. In another embodiment, the shield 52 is non-vented and does not have bleed vents or a groove.

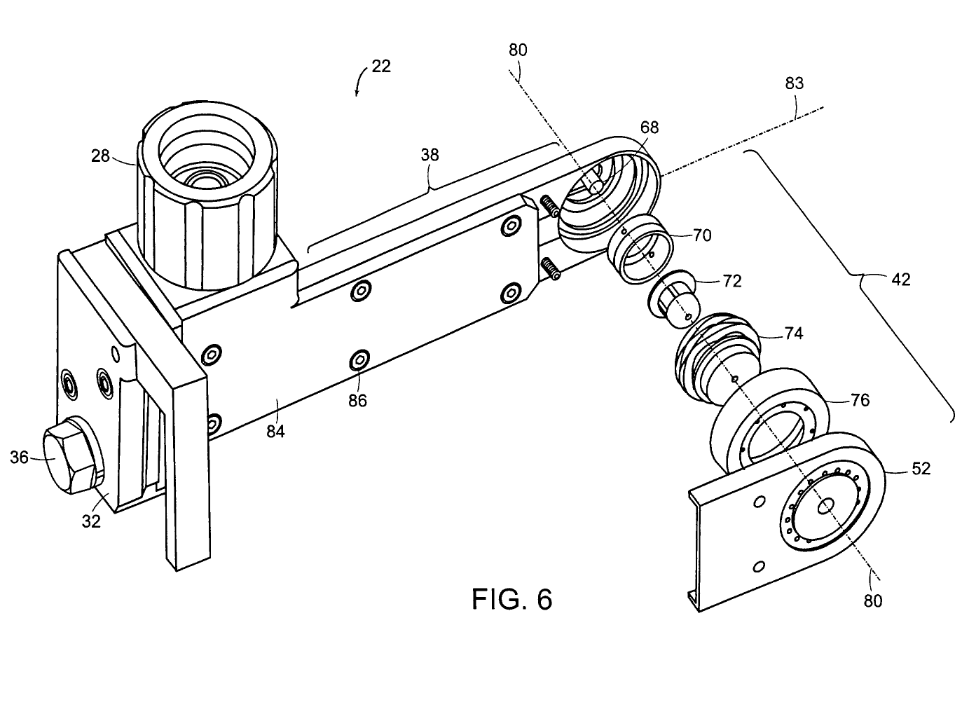

FIGS. 5 and 6 show exploded views of the remote torch head 42, with and without the neckpiece cover 84 attached to the adapter 22 with neckpiece cover screws 86. The remote torch head 42 includes a central exit orifice 81 in the shield 52 through which the plasma arc 44 passes. The neckpiece cover 84 is attached to the adapter 22 with neckpiece cover screws 86. The central exit orifice 81 can be conical, cylindrical, substantially planar, or some combination of the foregoing. The front face of the shield 52A defines the central exit orifice through which the plasma arc 44 exits the shield. In some embodiments, the exit orifice 81 is generally coplanar with the front face 22A of the adapter.

The remote torch head 42 includes an electrode 72 and a nozzle 74 positionable in a spaced relationship to define a plasma chamber 78 in which the plasma arc 44 is formed. As shown, a plasma gas flow path of the plasma arc 44 flows in a direction parallel with the axis of the torch head 80 and substantially transverse to the longitudinal axis of the adapter 83. This transverse flow orientation facilitates the low-profile design of the shield 52 and remote torch head 42, enabling them to be operated within the confines, for example, of a cavity 14. The remote head 42 of the plasma arc torch can thus be used to cut a workpiece within tight space constraints, in ways that were not previously possible.

For example, as discussed above the torch body can be manipulated about an axis 29 of the rotatable attachment 28, to achieve an angle a with the adapter selected by a user (FIG. 1B). However, the torch can also be rocked about the longitudinal axis 83 of the adapter 22 (FIG. 3A, FIG. 5), such that the plasma arc 44 impinges on and cuts the workpiece, for example within the cavity 14. Further, the entire torch can be rotated about a longitudinal axis 12A of the workpiece, such that the workpiece longitudinal axis 12 and the adapter longitudinal axis 83 remain substantially parallel, while cutting the workpiece with the plasma arc 44. Thus, there are at least three rotational options available to a user of the torch, enhancing its versatility.

The plasma arc torch system described above can be easily positioned in a tight space to allow cutting of tendons that are only a few inches apart. The remote torch head is easily positionable within the tight space using the adapter that connects it to the torch body. The rotatable attachment also provides for a convenient orientation of the torch body with respect to the adapter and the torch head, to minimize any interference with surrounding objects while the cut is being made. The length of the adapter provides versatility in where along a workpiece a cut is made. These are advantages over current hydraulic and oxy-fuel methods, which require a much larger access area to reach each tendon and perform a similar cut.

Equivalents

While the invention has been particularly shown and described with reference to specific referred embodiments, it should be understood by those skilled in the art that various changes in form and detail may be made therein without departing from the spirit and scope of the invention.

1. An adapter for enabling a plasma arc torch to cut a portion of a workpiece disposed within a cavity, the plasma arc torch having a torch body and a torch head, the adapter comprising:
a neckpiece connectable to the torch head and the torch body such that (1) the torch head is disposed in a spaced relationship relative to the torch body and (2) the torch head is positionable within the cavity adjacent the workpiece,
the neckpiece comprising flow paths for providing electrical current and at least one gas from the torch body to the torch head.

2. The adapter of claim 1 further comprising a rotatable attachment disposed adjacent to a first end of the neckpiece and connectable to the torch body of the plasma arc torch, wherein the rotatable attachment provides for a flow of the electrical current and the at least one gas between the torch body and the neckpiece.

3. The adapter of claim 2 wherein the rotatable attachment allows for user-selectable orientation of the torch body about an axis of the rotatable attachment.

4. The adapter of claim 1, wherein the flow paths comprise at least one of a primary current lead and a pilot arc lead to transfer a primary current or a pilot arc current to the torch head.

5. The adapter of claim 1, wherein the flow paths comprise a plasma gas flow path to transfer a plasma gas from the torch body to the torch head.

6. The adapter of claim 1 further comprising a grounding portion fixedly mounted to a first end of the neckpiece to maintain electrical continuity between the workpiece and a power supply to the plasma arc torch.

7. The adapter of claim 1 further comprising:
a clamping plate disposed adjacent a first end of the neckpiece, the clamping plate having an interior surface disposed opposite a surface of the adapter; and
a tensioning member that creates a biasing compressive force between the interior surface of the clamping plate and the surface of the adapter, such that a severed portion of the workpiece is retained between the interior surface of the clamping plate and the surface of the adapter.

8. An adapter for use with a plasma arc torch for cutting a workpiece having at least a portion disposed within a cavity, the plasma arc torch having a torch body and a torch head, the adapter comprising:
a neckpiece connectable to the torch head and the torch body such that the torch head is disposed in a spaced relationship relative to the torch body, the neckpiece comprising flow paths for providing electrical current and at least one gas from the torch body to the torch head; and
a grounding portion fixedly mounted to a first end of the neckpiece to maintain electrical continuity between the workpiece and a power supply to the plasma arc torch.

9. The adapter of claim 8, wherein the grounding portion further comprises a strain relief member.

10. The adapter of claim 9, wherein the strain relief member further comprises a pass-through hole for supporting a grounding cable.

11. The adapter of claim 8 further comprising:
a clamping plate disposed adjacent the first end of the neckpiece, the clamping plate having an interior surface disposed opposite a surface of the adapter; and
a tensioning member that creates a biasing compressive force between the interior surface of the clamping plate and the surface of the adapter, such that a severed portion of the workpiece is retained between the interior surface of the clamping plate and the surface of the adapter.

12. An adapter for use with a plasma arc torch for cutting a workpiece having at least a portion disposed within a cavity, the plasma arc torch having a torch body and a torch head, the adapter comprising:
a neckpiece connectable to the torch head and the torch body such that the torch head is disposed in a spaced relationship relative to the torch body, the neckpiece having a first end and a second end;
a clamping plate extending from the neckpiece, the clamping plate having an interior surface disposed opposite a surface of the adapter; and
a tensioning member disposed between the clamping plate and the adapter that creates a biasing compressive force between the interior surface of the clamping plate and the surface of the adapter, such that the portion of the workpiece is retained between the interior surface of the clamping plate and the surface of the adapter.

13. The adapter of claim 12 wherein the clamping plate further comprises a retainer disposed along the interior surface, the retainer retaining a severed portion of the workpiece between the clamping plate and the surface of the adapter.

14. The adapter of claim 13 wherein the retainer comprises an interior retention ridge.

15. The adapter of claim 12 further comprising a grounding portion fixedly mounted to the first end of the neckpiece, to maintain electrical continuity between the workpiece and a power supply to the plasma arc torch.

16. A plasma arc torch tip for processing a workpiece having at least a portion disposed within a cavity, comprising:
a torch head for generating a plasma arc for processing the workpiece, the torch head comprising an electrode and a nozzle disposed in a spaced relationship to define a plasma chamber in which the plasma arc is formed; and
an adapter comprising a neckpiece connectable to the torch head and a torch body of a plasma arc torch such that the torch head is disposed in a spaced relationship relative to the torch body and is positionable within the cavity adjacent the workpiece, the neckpiece comprising flow paths for providing electrical current and at least one gas from the torch body to the torch head to generate and sustain the plasma arc.

17. The plasma arc torch tip of claim 16, wherein the torch head further comprises a substantially planar shield, a front face of the shield disposed adjacent a front face of the adapter, wherein a plasma gas flow path through the plasma chamber is substantially transverse to a longitudinal axis of the adapter.

18. The plasma arc torch tip of claim 16, wherein the nozzle comprises an exit orifice which is substantially coplanar with a front face of the adapter, and wherein a plasma gas flow path through the plasma chamber is substantially transverse to a longitudinal axis of the adapter.

19. The plasma arc torch tip of claim 17 wherein the torch head further comprises at least one of a swirl ring and a retaining cap.

20. The plasma arc torch tip of claim 17 wherein the substantially planar shield is vented or non-vented.

21. The plasma arc torch tip of claim 17 wherein one or more bleed vents are disposed in a groove or on a side wall of the shield.

22. The plasma arc torch tip of claim 16 further comprising a grounding portion fixedly mounted to a first end of the neckpiece to maintain electrical continuity with the workpiece.

23. The plasma arc torch tip of claim 16 further comprising:
a clamping plate disposed adjacent a first end of the neckpiece, the clamping plate having an interior surface disposed opposite a surface of the adapter; and
a tensioning member that creates a biasing compressive force between the interior surface of the clamping plate and the surface of the adapter, such that the portion of the workpiece is retained between the interior surface of the clamping plate and the surface of the adapter.

24. A plasma arc torch for processing a workpiece having at least a portion disposed within a cavity, comprising:
a plasma arc torch body;
a torch head for generating a plasma arc for processing the workpiece, the torch head comprising an electrode and a nozzle disposed in a spaced relationship to define a plasma chamber in which the plasma arc is formed; and
an adapter comprising a neckpiece for positioning the torch body in a spaced relationship relative to the remote torch head, the neckpiece comprising flow paths for providing electrical current and at least one gas from the torch body to the remote torch head, wherein the flow paths are substantially transverse to the plasma arc, and the remote torch head and a portion of the adapter fit within the cavity when processing the portion of the workpiece disposed within the cavity.

25. The plasma arc torch of claim 24 further comprising a power supply electrically coupled to the adapter for providing electrical current thereto.

26. The plasma arc torch of claim 25 further comprising a grounding portion fixedly mounted to a first end of the neckpiece to maintain electrical continuity between the workpiece and the power supply.

27. The plasma arc torch of claim 24 further comprising:
a clamping plate disposed adjacent a first end of the neckpiece, the clamping plate having an interior surface disposed opposite a surface of the adapter; and
a tensioning member that creates a biasing compressive force between the interior surface of the clamping plate and the surface of the adapter, such that a severed portion of the workpiece is retained between the interior surface of the clamping plate and the surface of the adapter.

28. A method for cutting a portion of a workpiece disposed within a generally circular cavity using a plasma arc torch comprising a torch body and a torch tip, the workpiece having a workpiece longitudinal axis extending therethrough, the method comprising:
inserting at least a portion of the torch tip within the generally circular cavity, the torch tip comprising (1) a plasma arc torch head for generating a plasma arc that impinges upon the portion of the workpiece disposed within the generally circular cavity, and (2) an adapter for positioning the torch head in a spaced relationship relative to a torch body, the adapter having an adapter longitudinal axis extending therethrough; and
manipulating the torch tip within the generally circular cavity to cut the workpiece with the plasma arc, such that the workpiece longitudinal axis and the adapter longitudinal axis remain substantially parallel.

29. The method of claim 28 wherein manipulating the torch tip comprises at least one of rocking the torch tip about the adapter longitudinal axis and rotating the torch tip about the workpiece longitudinal axis.

30. The method of claim 28 further comprising:
providing a rotatable attachment connectable to the torch body, wherein the rotatable attachment provides for a flow of electrical current and at least one gas between the torch body and the adapter; and
manipulating the torch body about an axis of the rotatable attachment to achieve a selected orientation with respect to the adapter.

31. The method of claim 28 further comprising removing the portion of the workpiece.

32. The method of claim 28 further comprising grounding the workpiece with a power supply to the plasma arc torch utilizing a grounding portion that is fixedly attached to the adapter.

33. The method of claim 28 further comprising retaining the portion of the workpiece using a clamping member that is fixedly attached to the plasma torch.

34. A method for cutting a portion of a workpiece disposed within a cavity using a plasma arc torch having a power supply, a torch body, and a torch tip, the method comprising:
inserting at least a portion of a remote plasma arc torch tip within the cavity, the torch tip comprising a torch head for generating a plasma arc that impinges upon the portion of the workpiece disposed within the cavity and an adapter for positioning the plasma arc head in a spaced relationship relative to the torch body;
electrically connecting the workpiece with the power supply using a grounding member fixedly attached to the adapter; and
manipulating the torch tip within the cavity to cut the workpiece with the plasma arc.

35. The method of claim 34 further comprising:
providing a rotatable attachment connectable to the torch body, wherein the rotatable attachment provides for a flow of electrical current and at least one gas between the torch body and the adapter; and
manipulating the torch body about an axis of the rotatable attachment to achieve a selected orientation with respect to the adapter.

36. A method for cutting a cable disposed within a cavity, the method comprising:
providing a plasma arc torch having a torch body and a torch head, an adapter connecting the plasma arc head in a spaced relationship with the torch body, the adapter comprising flow paths for providing electrical current and at least one gas from the torch body to the torch head;
inserting the torch head and at least a portion of the adapter into the cavity such that the torch head is adjacent to the cable;
generating a plasma arc;
manipulating the torch head within the cavity to cut the cable with the plasma arc.

37. A low-profile shield for use on a plasma arc torch head capable of cutting a portion of a workpiece disposed within a cavity, the plasma arc torch head disposed within the cavity and having a nozzle and an electrode disposed in a spaced relationship to define a plasma chamber in which a plasma arc is formed, an adapter connecting the plasma arc torch head and a plasma arc torch body in a spaced relationship, the shield comprising:
a substantially planar body portion having a front face disposed adjacent a face of the adapter for substantially preventing molten material generated during cutting of the workpiece from reaching the nozzle and electrode, the substantially planar body portion defining a central exit orifice through which the plasma arc exits the shield; and
a fastening mechanism disposed relative to the substantially planar body portion for securing the shield to the torch head, wherein the substantially planar body portion has at least one side surface dimensioned to minimize the profile of the torch head.

38. The low-profile shield of claim 37 further comprising one or more bleed vents.

39. The low-profile shield of claim 38 wherein one or more bleed vents are located in a recessed groove on a front face of the low-profile shield.

40. The low-profile shield of claim 38 wherein one or more bleed vents are disposed on a side wall of the shield.

41. The low-profile shield of claim 37 wherein the low-profile shield is non-vented.

42. The low-profile shield of claim 39 wherein the substantially planar body portion comprises a generally circular portion surrounded by a frame portion.
